(19) United States
(12) Patent Application Publication
(10) Pub. No.: US 2015/0077236 A1
(43) Pub. Date: Mar. 19, 2015

(54) Position Detecting System

(71) Applicant: Cycle Alert Holdings Limited, London (GB)

(72) Inventor: Peter Le Masurier, London (GB)

(73) Assignee: Cycle Alert Holdings Limited, London (GB)

(21) Appl. No.: 14/389,064

(22) PCT Filed: Mar. 28, 2013
(86) PCT No.: PCT/GB2013/050823

§ 371 Date: Sep. 29, 2014

(30) Foreign Application Priority Data
Mar. 29, 2012 (GB) GB1205533.8

(51) Int. Cl. G08G 1/16

(52) U.S. Cl. CPC G08G 1/16
USPC 340/435

(57) ABSTRACT

A position detecting system 10 for installation on a large vehicle 12 comprises a detector 14 for detecting a transmitter 32 on a vulnerable vehicle such as a bicycle 34, a processor for calculating the position of the bicycle relative to the large vehicle, and a user interface 100 for providing a visual indication of said position.

### CLAIM OF BENEFIT AND PRIORITY FROM EARLIER FILED PATENT APPLICATIONS

This application claims the benefit of and priority from International Patent Application No. PCT/GB2013/050823, filed Mar. 28, 2013, entitled Position Detecting System (said application designating the U.S.), and Great Britain Patent Application No. GB1205544.8, filed Mar. 29, 2012, entitled Position Detecting System, pursuant to 37 U.S.C. §371 and 37 C.F.R. §1.495. The inventor disclosed in said prior applications is the same as the inventor of the instant application, and the subject matters and disclosures of said prior applications is substantially identical to that of the instant application.

### FIELD OF THE INVENTION

The present invention relates to a position detecting system, and particularly but not exclusively to a system for the avoidance of collisions between large vehicles and bicycles.

### BACKGROUND TO THE INVENTION

Systems which detect the presence of bicycles in the vicinity of a large vehicle (for example a lorry) are known. Such systems typically comprise a series of cameras mounted on the lorry and a video display system inside the lorry cab for displaying the view from each camera. The cameras are arranged to cover the areas around the lorry which are not visible to the driver in the lorry mirrors (the ‘blindspots’).

The disadvantage of this system however is that it relies on the driver processing a great deal of visual data (both from the cameras and the lorry mirrors), and thus is not very effective at giving the driver a simple and quick warning when a vulnerable vehicle is near. In addition, the system is not able to distinguish between vulnerable vehicles (such as bicycles) and non-vulnerable vehicles which happen to pass through the blindspots (such as motorcycles passing the lorry).

An alternative system includes means for detecting the presence of an object in the lorry's blindspot and then alerting the driver to the presence of the object by sounding an alarm or activating a warning light. The means for detecting can comprise a radar system or proximity sensor. The disadvantage of this system however is that it can be activated by the presence of objects which are not in the class of ‘vulnerable vehicles’, such as motorcycles, cars or lorries or even street furniture such as bollards or streetlights.

US 2004/0217851 (Reinhart) discloses an obstacle detection system comprising at least one sensing device and an interface device. Other prior art systems are disclosed in JP 2001315601 (NEC); US 2007/182528 (Breed); JP 2007334849 (Hanami); DE 102006026898 (Dominik); GB 2468502 (Plaza); and EP 1944212 (Bosch).

It is an object of this invention to provide a position detecting system which reduces or substantially obviates the above mentioned problems.

### SUMMARY OF INVENTION

According to a first aspect of the present invention, there is provided a position detecting system comprising:

(a) a transmitter for association with a first object (such as a bicycle),

(b) at least one detector for association with a second object (such as a lorry), the detector being configured to detect the transmitter,

(c) a processor for calculating the position of the transmitter relative to the detector, and

(d) a user interface for providing a visual indication of said position.

The advantage of this system is it is activated only by an object which is carrying or on which is mounted a transmitter. Thus the system avoids the false alerts which are a feature of many proximity sensors.

Additionally, the deployment of a simple user interface which provides a visual indication of the position of the transmitter relative to the detector (and therefore the position of the bicycle, for example, relative to the lorry) means that the lorry driver does not have to process complicated visual data provided by a series of cameras (as with existing systems).

The transmitter may be built into or mounted on the frame of a bicycle or alternatively built into or mounted on the cyclist's helmet, bag, footwear or clothing.

The system may be deployed in other scenarios, for example the transmitter may be mounted on a bicycle and the detector may be associated with traffic lights or other road management systems, such as warning signs at junctions and the like. Thus the traffic lights or warning signs can be programmed to be triggered when a bicycle is within range, to enable priority to be given to the bicycle over other road users for example.

Alternatively, the transmitter may be carried by a vulnerable worker in a building site or factory, for example, and the detector(s) mounted on dangerous machinery.

In a preferred embodiment, the user interface provides a visual indication which is located on the user interface in a position which is representative of the position of the transmitter relative to the user interface. For example, the user interface may have four visual indicators at the top, bottom, left and right hand sides of the user interface, wherein the top visual indicator indicates that the transmitter is in front of the user interface, the bottom visual indicator indicates that the transmitter is behind the user interface, the left hand visual indicator indicates that the transmitter is to the left of the user interface, and the right hand visual indicator indicates that the transmitter is to the right of the user interface.

In one embodiment, means may be provided for determining the approximate distance of the transmitter from the detector. Thus the user interface might be adapted to provide an indication of said distance, for example by changing the colour of the visual indicators as the distance decreases. Preferably, the user interface provides a visual indication of said position only when the transmitter is within a pre-programmed distance from the detector, wherein said distance is less than the maximum detection range of the detector. In other words, the system may be programmed to act as a proximity sensor wherein bicycles outside of a pre-set range are ignored.

However, the user interface may additionally include a visual indicator (such as a centre light) for indicating when the transmitter is at a distance from the detector which is greater than said pre-programmed distance and less than the maximum detection range of the detector. In other words, the driver could be given a first signal (for example by a centre light) when a bicycle is within range of the detector (but not a signal indicating the bicycle's position), and a second signal which indicates the bicycle's position when it comes closer to the lorry. The advantage of this first signal is that it acts as a very simple first alert to the driver, following which he can pay more attention to the system in case the bicycle comes closer. This might be useful, for example, at non-peak hours when there are not many bicycles on the road.

The user interface may be programmed to have different alerts for example an audio alert in addition to the visual alert. It may also be programmed to have different alerts to identify different transmitters.

In a particularly preferred embodiment, each or preferably all of the components of the system communicate wirelessly.

According to a second aspect of the present invention, there is provided a position detecting system for installation on a large vehicle comprising a detector for detecting a vulnerable vehicle such as a bicycle, a camera and a video display. The video display is activated to show a live feed from the camera when a vulnerable vehicle is detected.

The system is advantageous because it provides a warning to the driver of the large vehicle that a vulnerable vehicle is in the vicinity. It also shows the driver a live image of the vulnerable vehicle so that, even when the vulnerable vehicle is not visible to the driver through the windows or via the mirrors, the driver is aware of the position and motion of the vulnerable vehicle in relation to the large vehicle which he is driving. The system is intuitive to the driver in use, since the display of the vulnerable vehicle complements the mirrors which the driver is already well used to using.

The image from the camera may be flipped laterally before it is displayed on the video display. In this way, the driver may interpret the image in exactly the same way as he interprets an image in a mirror.

The detector may comprise of a radio receiver to receive a signal transmitted by a tag which may be attached to a vulnerable vehicle.

It is anticipated that many tags could be manufactured at low cost, and would be installed by, for example, cyclists on their bicycles. Tags could also be integrated into new bicycles in manufacture. Vehicles fitted with the position detecting system would then be able to reliably detect bicycles and other vulnerable vehicles which had tags fitted.

The detector may alternatively or additionally be provided by the camera, or an additional camera, together with software for detecting the characteristic shape or motion of a vulnerable vehicle, for example a bicycle.

The advantage of this arrangement is that all vulnerable vehicles may be detected, whether or not transmitting tags have been fitted. Combining a tag-based system with a shape-detection system combines this advantage with the reliability of detection offered by a tag-based system.

The detector may alternatively or additionally be provided by the camera, or an additional camera, together with software for detecting the presence of a reflective tag in the image from the camera.

The reflective tag may be designed to create a distinctive fingerprint in the camera image, thus increasing the reliability of detection over a purely shape and motion based detection system. Reflective tags do not require power and are cheaper to manufacture than transmitting tags.

Where the detector looks for a distinctive tag, the tag may be specifically designed to reflect infra-red light. An infra-red light source may be provided as part of the position detecting system. This arrangement allows the system to operate successfully in low-light conditions, without flooding the street with visible light.

Means may be provided for determining the approximate distance of the vulnerable vehicle from the large vehicle. Means may also be provided for determining the approximate position of the vulnerable vehicle in relation to the large vehicle.

Where the approximate position of the vulnerable vehicle may be established, multiple cameras may be provided, and a camera may be selected for streaming to the video display based on the position of the vulnerable vehicle.

In this way, multiple cameras may be positioned to cover the entire area surrounding a large vehicle. When a vulnerable vehicle is detected, the driver will immediately be able to see the vulnerable vehicle on the video screen, and can therefore take appropriate action to avoid a collision.

Alternatively or additionally, the direction and/or the zoom of the camera or cameras may be adjusted automatically based on the position of the vulnerable vehicle in relation to the large vehicle.

The video feed from the camera or cameras may be augmented in order to highlight the vulnerable vehicle on the video display. This enables the driver to quickly identify the vehicle which is being detected, even when visibility is poor, for example due to fog.

A processing unit may be provided for detecting whether the vulnerable vehicle is moving. This serves to eliminate false alarms caused by, for example, bicycles parked at the roadside.

A processing unit may be provided for detecting whether the vulnerable vehicle is on course to collide with the large vehicle. Alternatively or additionally, the processing unit may detect whether the vulnerable vehicle is exhibiting erratic or unpredictable motion. This has the advantage that, in busy areas where the position detecting system might otherwise be raising almost constant alerts, leading the driver to become inclined to ignore the warnings, the system may be adjusted to only alert to the presence of vulnerable vehicles which are in particular danger, and to ignore, for example, a bicycle in a cycle lane which is in consistently parallel motion to the large vehicle.

Where such a processing unit is provided, the output may be presented on the video display. Such presentation may comprise of letters, symbols, or lines and arrows and the like superimposed upon the video image. Audible and/or visual warning other than on the video display may alternatively or additionally be provided dependent on the output of the processing unit.

Audible and/or visual warning other than on the video display may be provided whenever a vulnerable vehicle is in proximity.

Any of the various above mentioned components of the position detecting system may communicate with each other by wireless means. Wireless communications provide the advantage of easier fitting to a large vehicle, since no wiring need be installed. Where the position detecting system is fitted to a large vehicle which comprises of a cab and a trailer, it is particularly advantageous to reduce or eliminate the need for wiring between the cab and the trailer, since the trailer may be detached from the cab.

The wireless communication means may conform to the Zigbee™ standard.

The position detecting system may be activated only when the large vehicle is turning. Alternatively or additionally, it may be activated when the large vehicle is reversing. Turning or reversing large vehicles present a particular hazard to bicycles and other vulnerable vehicles, and so it may be advantageous to provide a position detecting system only in that situation. By deactivating the position detecting system when the large vehicle is travelling forwards in a straight line, the overall number of alerts will be reduced and the driver will therefore be less inclined to ignore alerts when they do occur.

Any of the above mentioned component parts of the position detecting system may be powered by batteries. Alternatively or additionally, any of the component parts may be powered by solar cells. Batteries provide a reliable source of power even in darkness, whereas solar cells have the advantage that they do not need regular replacement. In combination, batteries may provide a back-up power source when darkness means that the solar cells are unable to provide sufficient power. The solar cells therefore increase the longevity of the batteries, and may charge the batteries in sunlight.

A sucker cup may be provided on the video display so that it may be attached to a windscreen.

### DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a large vehicle fitted with a first embodiment of a position detecting system;

FIG. 2 shows a plan view from above of the large vehicle of FIG. 1 fitted with a first embodiment of a position detecting system;

FIG. 3 shows a perspective view of an LED display device, being a component part of the first embodiment of a position detecting system;

FIG. 4 shows a perspective view of a video display device, being a component part of the first embodiment of a position detecting system;

FIG. 5 shows a front view of the video display device of FIG. 4;

FIG. 6 shows a plan view from above of a large vehicle fitted with a second embodiment of a position detecting system; and

FIG. 7 shows a front view of an alternative display device to that shown in FIG. 3.

### DESCRIPTION OF PREFERRED EMBODIMENTS

### Video Camera Embodiment

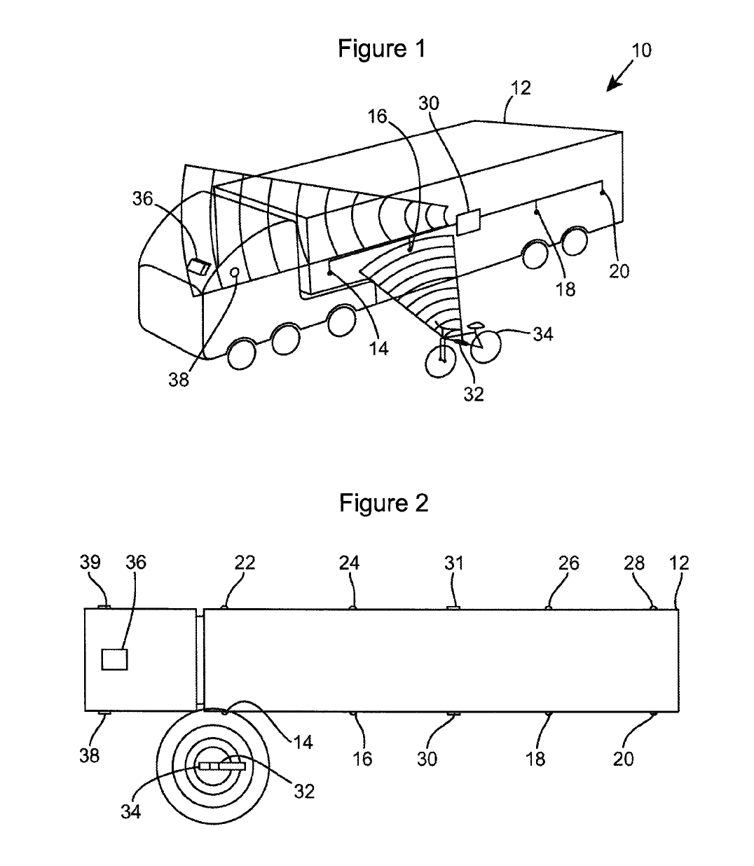

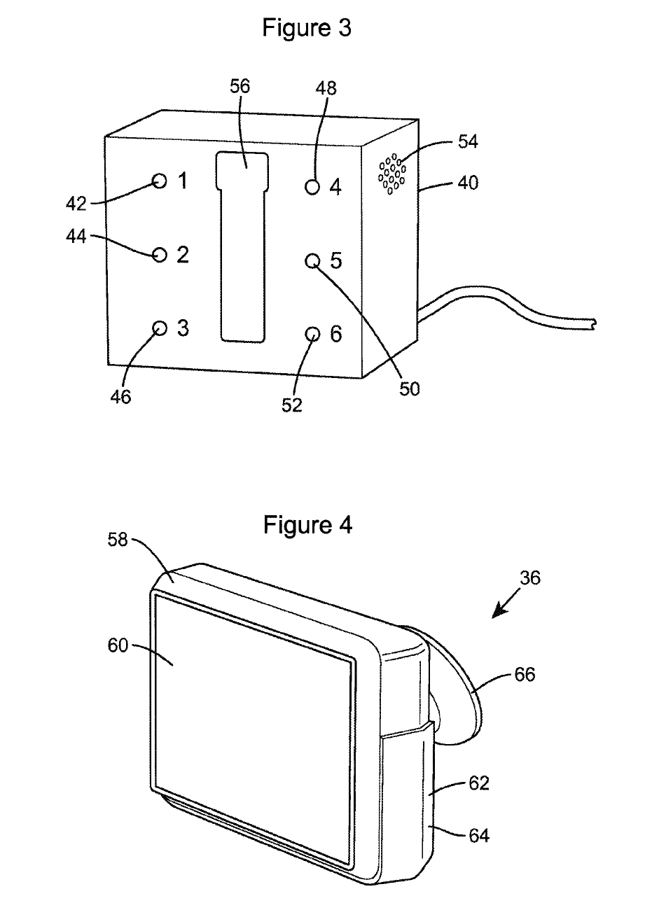

Referring firstly to FIGS. 1 and 2, a first embodiment of a position detecting system is shown generally at 10. The position detecting system 10 comprises eight antennas 14, 16, 18, 20, 22, 24, 26, 28 four of which are fitted spaced out at regular intervals along each side of a large vehicle 12.

Four antennas 14, 16, 18, 20 communicate wirelessly with a first receiver 30 which is mounted to the left-hand side of the large vehicle 12. A further four antennas 22, 24, 26, 28 communicate wirelessly with a second receiver 31 which is mounted to the right-hand side of the large vehicle 12. A transmitting tag 32 is attached to a bicycle 34. A first camera 38 is mounted at a high level on the left-hand side of the cab of the large vehicle 12, and a second camera 39 is mounted at a high level on the right-hand side of the cab of the large vehicle 12. The lens of the first camera 38 is directed to cover an area extending along the entire left side of the large vehicle 12, and the lens of the second camera 39 is directed to cover an area extending along the entire right side of the large vehicle 12.

When either of the first and second receivers 30, 31 receives a radio signal from the transmitting tag 32, the receiver sends a signal to a video display unit 36 which is located in the cab of the large vehicle 12. The video display unit 36 is then activated to show a live image 37 from one of first and second cameras 38, 39.

Where the radio signal is received by the first receiver 30, the video display unit 36 will show a live image 37 from the first camera 38. Where the radio signal is received by the second receiver 31, the video display unit 36 will show a live image 37 from the second camera 39.

The first receiver is able to identify which of antennas 14, 16, 18, 20 received a radio signal from the transmitter 32, and the second receiver is able to identify which of antennas 22, 24, 26, 28 received a radio signal from the transmitter 32. The receivers 30, 31 are able to measure the relative strength of the radio signal from each antenna, and also the time difference in reception of the radio signal between adjacent antennas. In this way, the approximate position of the transmitter 32 in relation to the large vehicle 12 can be calculated. The approximate position is transmitted to an LED display unit 40 in the cab, and to the cameras 38, 39.

The first and second cameras 38, 39 are mounted on motorised adjustable mountings, so that the direction of either of the cameras can be adjusted automatically. The cameras 38, 39 are also provided with motorised zoom lenses, so that the zoom of either of the cameras can be adjusted automatically. When either of the cameras 38, 39 receives positional information from either of the receivers, the direction and zoom of the camera 38 or 39 will be adjusted automatically to obtain a field of view which includes the area in which a transmitting tag 32 is located.

The LED display unit 40 comprises six LEDs 42, 44, 46, 48, 50, 52 and a sounder 54. The six LEDs 42, 44, 46, 48, 50, 52 are arranged in two columns of three LEDs. A diagram 56 showing a top view of the large vehicle 12 is printed between the columns of LEDs on the surface of the LED display unit 40. The first LED 42 is illuminated to indicate the presence of a transmitting tag 32 in a front left-hand zone around the large vehicle 12, the second LED 44 is illuminated to indicate the presence of a transmitting tag 32 in a central left-hand zone around the large vehicle 12, the third LED 46 is illuminated to indicate the presence of a transmitting tag 32 in a rear left-hand zone around the large vehicle 12, and the fourth, fifth, and sixth LEDs 48, 50, 52 are illuminated to indicate the presence of a transmitting tag in respectively front, central and rear right-hand zones around the large vehicle 12. The sounder 54 is activated whenever a transmitter 32 is detected in proximity to the large vehicle 12.

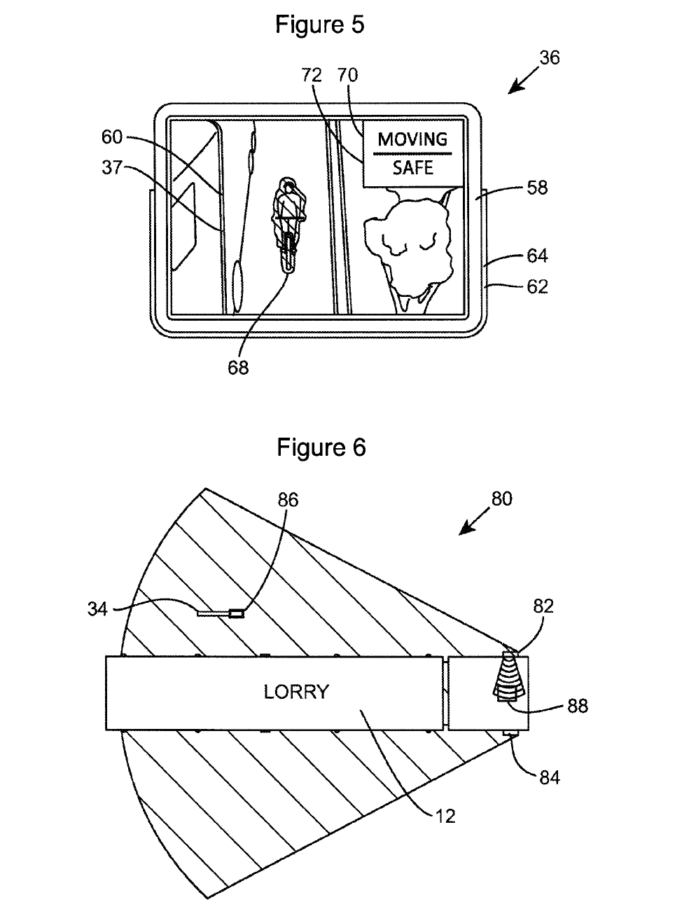

Referring now to FIGS. 4 and 5, the video display 36 is substantially rectangular, comprising a housing 58 which is made from plastics, and a single LCD screen 60. A display fitment 62 is provided for attaching the video display 36 to a windscreen of a vehicle. The display fitment 62 comprises a bracket 64 and a sucker cup 66 attached to the read of the bracket. The bracket 64 is formed from a three-sided frame designed to receive the bottom portion of the rectangular housing 58, so that the video display 36 may be moved vertically into and out of the bracket 64.

The position of the transmitting tag 32 calculated by the receivers 30, 31, is used together with shape-detection software in order to highlight the location of the bicycle 34 in the video image 37 on the video display 36. The entire image 37 is also flipped laterally before being displayed. The image 37 in FIG. 5 is from the second camera 39 which is mounted on the right-hand side on the large vehicle 12. The image 37 on the display therefore has the appearance of the image in a right-hand wing mirror of a vehicle.

Signal processing software takes the positional information from the receivers 30, 31 at regular intervals and uses it to calculate whether the transmitting tag 32 is moving, whether it is on a collision course with the large vehicle 12, and whether the motion of the tag 32 is erratic or unpredictable. This information is presented to the driver of the large vehicle 12 in an upper right region of the video display 36. An upper section 70 of the information display region shows whether the detected tag 32 is moving, and a lower section 72 shows whether the detected motion is SAFE (that is, unlikely to result in a collision), DANGEROUS (a collision is likely), or ERRATIC (the motion is unpredictable). The sounder 54 in the LED display unit 40 sounds briefly at a low pitch when the detected motion is safe, and sounds repeatedly at a high pitch when the detected motion is dangerous or erratic.

The receivers 30, 31, the video display 36, the cameras 38, 39 and the LED display 40 all communicate with each other over a Zigbee™ wireless network. The above mentioned components are powered by rechargeable batteries, which are recharged in daylight by solar cells.

### Infra-Red Camera Embodiment

Referring now to FIG. 6, a second embodiment of a position detecting system is shown generally at 80, and comprises of first and second infra-red cameras 82, 84, the first camera being mounted at a high point on the front left-hand side of the large vehicle 12, and the second camera being mounted at a high point on the front right-hand side of the large vehicle 12. An infra-red light source is provided in each camera to flood the area surrounding the vehicle with infra red light. A reflective tag 86 is attached to the bicycle 34 and is of a distinctive shape, so that it can easily be recognised by software processing the images from the cameras 82, 84.

When a distinctive tag 86 is identified in the field of view of one of the cameras 82, 84, the video stream is transmitted from the camera to a video display 88 in the driver's cab.

Both the first and second embodiments described above allow a driver to be alerted to the presence of a vulnerable vehicle, and to see a live image of the vulnerable vehicle in order that appropriate action may be taken to avoid a collision.

### Camera-Free Embodiment

A preferred embodiment does not utilise any cameras or has the cameras of the first two embodiments switched off. In this embodiment, as before four antennas 14, 16, 18, 20 communicate wirelessly with a first receiver 30 which is mounted to the left-hand side of the large vehicle 12. A further four antennas 22, 24, 26, 28 communicate wirelessly with a second receiver 31 which is mounted to the right-hand side of the large vehicle 12. A transmitting tag 32 is attached to a bicycle 34.

When either of the first and second receivers 30, 31 receives a radio signal from the transmitting tag 32, the receiver sends a signal to a processor (not shown). The processor is able to identify which of antennas 14, 16, 18, 20 received a radio signal from the transmitter 32, and which of antennas 22, 24, 26, 28 received a radio signal from the transmitter 32. The receivers 30, 31 are able to measure the relative strength of the radio signal from each antenna, and also the time difference in reception of the radio signal between adjacent antennas. In this way, the approximate position of the transmitter 32 in relation to the large vehicle 12 can be calculated and the approximate position is transmitted to an LED display unit 40 in the cab which then functions as described above.

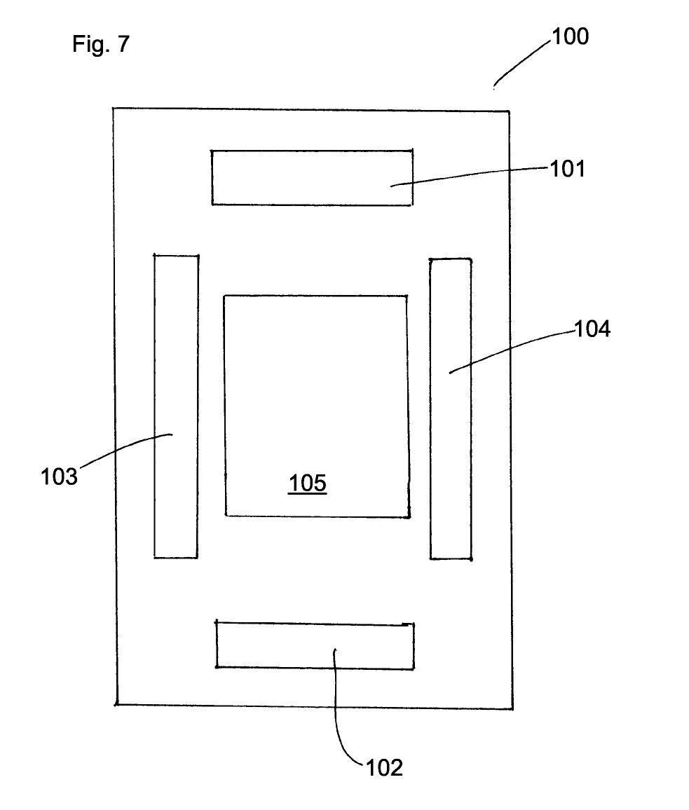

An alternative display device 100 is shown in FIG. 7. Device 100 has front light 101 at the top of the device, rear light 102 at the bottom of the device, left light 103 on the left hand side and right light 104 on the right hand side. In use, lights 101, 102, 103 & 104 light up when transmitter tag 32 (and therefore bicycle 34) is in front of, behind, to the left of or to the right of the vehicle 12 respectively. In addition, the processor may be programmed so that the lights 101, 102, 103 & 104 light up only when transmitter tag 32 is within a pre-set range (for example within 2 metres) of the relevant antenna.

Display device 100 also has a centre light 105, and the processor may be programmed so that this lights up when transmitter tag 32 is within detection range of the antennae, but further way than the pre-set range described above. Thus as described above, centre light 105 gives a simple first alert to the driver, following which he can pay more attention to the system in case the bicycle comes closer, at which point lights 101, 102, 103 & 104 enable the position of bicycle 34 to be identified.

The invention hereby claimed is:

1. A position detecting system comprising
(a) a transmitter for association with a first object,
(b) at least one detector for association with a second object, the detector being configured to detect the transmitter,
(c) a processor for calculating the position of the transmitter relative to the detector, and
(d) a user interface for providing a visual indication of said position.

2. A position detecting system as claimed in claim 1, wherein the user interface provides a visual indication which is located on the user interface in a position which is representative of the position of the transmitter relative to the user interface.

3. A position detecting system as claimed in claim 1, wherein the user interface has four visual indicators at the top, bottom, left and right hand sides of the user interface, and wherein the top visual indicator indicates that the transmitter is in front of the user interface, the bottom visual indicator indicates that the transmitter is behind the user interface, the left hand visual indicator indicates that the transmitter is to the left of the user interface, and the right hand visual indicator indicates that the transmitter is to the right of the user interface.

4. A position detecting system as claimed in claim 1, in which means are provided for determining the approximate distance of the transmitter from the detector.

5. A position detecting system as claimed in claim 1, wherein the user interface provides a visual indication of said position only when the transmitter is within a pre-programmed distance from the detector, wherein said distance is less than the maximum detection range of the detector.

6. A position detecting system as claimed in claim 5, wherein the user interface additionally provides a visual indication when the transmitter at a distance from the detector which is greater than said pre-programmed distance and less than the maximum detection range of the detector.

7. A position detecting system as claimed in claim 6, wherein said visual indication is proximate the centre of the user interface.

8. A position detecting system as claimed in claim 1, comprising four detectors which can be arranged in use in front of, behind, to the right of and to the left of the user interface.

9. A position detecting system as claimed in claim 1, additionally comprising a camera and a video display, wherein the processor automatically activates the video display to show a live feed from the camera when the transmitter is detected.

10. A position detecting system as claimed in claim 9, in which processor is configured to flip laterally the image from the camera before the image is displayed on the video display.

11. A position detecting system as claimed in claim 9, wherein the processor is programmed with shape-detection software to detect the characteristic shape or motion of an object detected by the camera.

12. A position detecting system as claimed in claim 9, wherein the processor is programmed with software to detect the presence of a reflective tag in the image from the camera.

13. A position detecting system as claimed in claim 12, in which the reflective tag is specifically designed to reflect infra-red light.

14. A position detecting system as claimed in claim 13, in which an infra-red light source is provided.

15. A position detecting system as claimed in claim 8, in which multiple cameras are provided, and in which a camera is selected for streaming to the video display based on the position of the transmitter in relation to the detector.

16. A position detecting system as claimed in claim 8, in which the direction and/or zoom of the camera is adjusted automatically based on the position of the transmitter in relation to the detector.

17. A position detecting system as claimed in claim 8, in which the video feed from the camera is augmented in order to highlight the first object on the video display.

18. A position detecting system as claimed in claim 1, wherein the processor is configured to detect movement of the transmitter.

19. A position detecting system as claimed in claim 1, wherein the processor is configured to detect whether the transmitter is on course to collide with the detector.

20. A position detecting system as claimed claim 1, wherein the processor is configured to detect whether the transmitter is exhibiting erratic or unpredictable motion.

21. A position detecting system as claimed in claim 18 in which the output from the processor is presented on a video display.

22. A position detecting system as claimed in claim 18, in which audible and/or visual warning other than on a video display is provided dependent on the output of the processor.

23. A position detecting system as claimed in claim 18, in which audible and/or visual warning other than on the video display is provided whenever the transmitter is in proximity.

24. A position detecting system as claimed in claim 1, in which the detector comprises a radio receiver to receive a signal transmitted by the transmitter.

25. A position detecting system as claimed in claim 1, in which any two of the components communicate with each other by wireless means.

26. A position detecting system as claimed in claim 1, in which the first object is mounted on a vehicle or on a person.

27. A position detecting system as claimed in claim 1, in which the second object is mounted on a vehicle, on machinery, on traffic lights or on warning signs.

28. A position detecting system as claimed in claim 27, in which the second object is mounted on a vehicle, and where the system is activated only when said vehicle is turning.

29. A position detecting system as claimed in claim 27, in which the second object is mounted on a vehicle, and where the system is activated only when said vehicle is reversing.
